(19) United States
(12) Patent Application Publication
(10) Pub. No.: US 2004/0201557 A1
(43) Pub. Date: Oct. 14, 2004

(54) Method and apparatus for achieving active matrix OLED display devices with uniform luminance

(76) Inventors: Shin-Tai Lo, Miaoli City (TW); Chih-Chung Chien, Taichung City (TW)

Correspondence Address: BIRCH STEWART KOLASCH & BIRCH, PO BOX 747, FALLS CHURCH, VA, 22040-0747, US

(21) Appl. No.: 10/408,548

(22) Filed: Apr. 8, 2003

(51) Int. Cl. G09G 3/32

(52) U.S. Cl. 345/82

(57) ABSTRACT

A method and apparatus for achieving an active matrix OLED display device which consists of a plurality of pixel devices with uniform luminance are described. Each of the pixel devices includes a driver unit to drive the OLED to illuminate and a compensation unit to adjust Vsg of the driver unit to compensate for the characteristic variations of the driver unit, thereby the luminance of the display device is less affected by the characteristic variations of the driver unit.

### FIELD OF THE INVENTION

The present invention relates to a method and apparatus for achieving active matrix OLED display devices with uniform luminance and particularly to a method and apparatus that automatically adjust the loading characteristic curve according to input voltage signals.

### BACKGROUND OF THE INVENTION

The known thin film transistor liquid crystal display (TFT LCD) technologies at present can be classified in amorphous silicon TFT (a-Si TFT) and Poly-Si TFT. The generally called TFT-LCD is a-Si TFT which is technically well developed and is the main stream of LCD products. The main difference between the low temperature Poly-Si TFT (LTPS TFT) and the a-Si TFT is that the LTPS transistor requires laser annealing during the manufacturing process to transform the amorphous silicon thin film to poly silicon thin film so that the silicon structure of the LTPS is aligned more orderly than a-Si TFT. It can increase electron mobility up to 200 cm2/V-sec. The LTPS technology enables elements to be made in a smaller size. The area of the whole TFT element can be shrunk 50% or more. The aperture ratio may also be improved. Comparing with a-Si TFT-LCD of the same dimension, LTPS TFT has a higher resolution and lower power consumption. Furthermore, LTPS TFT has other advantages such as power saving, greater light intensity, finer picture, thin and light, and fewer connection points (less than 200 connection points, that improves yields, while a-Si TFT has more than 3842 connection points).

However, in the manufacturing process of LTPS the thin film transistor has to go through a laser annealing operation that often results in changes of the threshold voltage and mobility of the TFT. Hence the characteristics of every TFT element are different. When a driver system uses analog modulation method to achieve the gray scale of the image, the different characteristics of the TFT resulted from the laser annealing operation cause OLEDs of different pixels to emit different intensity of light even if same voltage signals are programmed, and the OLED display with non-uniform luminance is occurred. This phenomenon makes the OLED panel to display erroneous gray scale images and severely damages image uniformity.

U.S. Pat. No. 5,684,365, entitled “TFT-el display panel using organic electroluminescent media” discloses a technique which has a pixel circuit consisting of two TFTs and a capacitor (2TIC). When the pixel device scans image data, the switch unit is conductive and image data enter in the switch unit through the data line. After scanning by the scan line, the data are stored in the storage unit (i.e. charge the storage unit after the switch unit is conductive). The voltage difference of the storage unit provides Vsg of the driver unit to enable the driver unit to output current to the OLED element. The brightness generated by the OLED element is in direct proportion to the current flow through it. However, if the characteristics of the driver unit of the pixel device vary due to manufacturing process, light generated by the OLED element is not even, and image uniformity will be damaged.

U.S. Pat. No. 6,229,506 entitled “Active matrix light emitting diode pixel structure and concomitant method” discloses a 4T2C pixel circuit. It has an auto-zero mechanism to compensate for the variation of transistor threshold voltage. When data are scanned, the driving sequence is divided in an auto-zero phase, a load data phase and an illuminate phase. However, in addition to data line, scan line and supply line, the pixel device requires auto-zero control line and illuminate control line. This results in decrease of the aperture ratio.

Refer to an article regarding “Pixel device for improving image uniformity of active matrix OLED” (IDW, 01) published by Electronic Research & Service Organization, Industrial Technology Research Institute (R.O.C.). It proposes a pixel device consisting of 2T1C+R, and has a passive resistor to adjust Vsg of the TFT of the driver unit to compensate for the variations of the characteristics. But including the passive resistor is difficult. Moreover, when the TFT has to output a greater amount of current, the voltage drop of the passive resistor is large. Hence it needs a higher power supply to provide voltage.

Refer to another article regarding “Amorphous TFT active matrix OLED display device” published by Jerzy Kanicki (University of Michigan, U.S.A.). It proposes a pixel device consisting of 3T1C that uses an active load to change Vsd of the TFT of the driver unit to compensate for the characteristic variations of the TFT. However, when the when the TFT has to output a greater amount of current, the voltage drop on the active load is large. Hence it needs a higher power supply to provide voltage.

### SUMMARY OF THE INVENTION

Therefore the primary object of the invention is to resolve the aforesaid disadvantages. The invention provides a method and apparatus for achieving active matrix OLED display devices with uniform luminance that has a pixel device which includes 3T1C structure. One of the TFTs serves as a compensation unit with auto-adjustment functions to compensate for the characteristic variations of the threshold voltage and mobility of a driver unit TFT thereby to improve image uniformity of the display device.

In order to achieve the foregoing object the display device according to the method and apparatus of the invention includes a plurality of pixel devices. Each pixel device has a driver unit to drive the OLED to illuminate and a compensation unit to adjust the Vsg of the driver unit to compensate for characteristic variations of the driver unit so that the image of the display device is less affected by the characteristic variations of the driver unit.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic circuit diagram of the invention.

FIG. 2 is a schematic chart of the current-voltage relationship of the compensation unit of the invention.

FIG. 3 is a schematic chart of the current-voltage relationship of the driver unit when Vth is smaller.

FIG. 4 is a schematic chart of the current-voltage relationship of the driver unit when Vth is larger.

FIG. 5 is a schematic chart of the current-voltage relationship of the compensation unit of the invention under different input voltage signals.

### DESCRIPTION OF THE PREFERRED EMBODIMENT

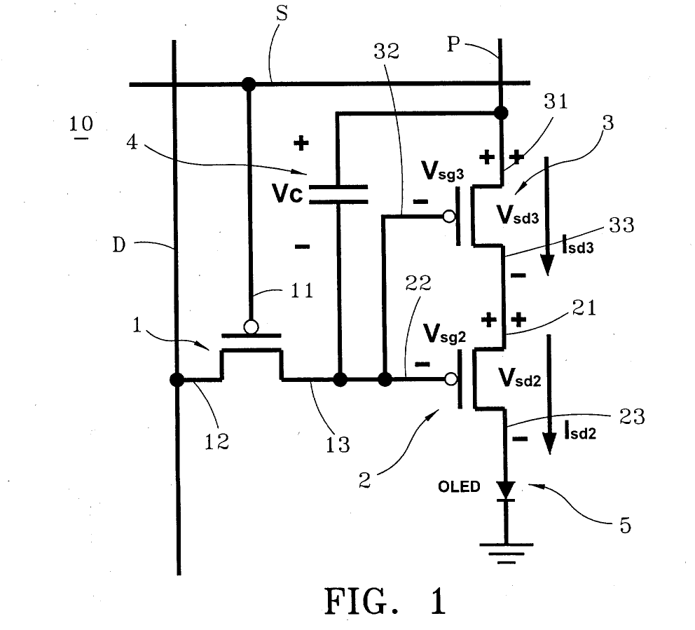

Refer to FIG. 1 for the circuit diagram of the invention. According to the method and apparatus of the invention, the active matrix OLED display device includes a plurality of pixel devices. Each pixel device has a driver unit to drive the OLED to illuminate and a compensation unit to adjust the Vsg of the driver unit to compensate for characteristic variations of the driver unit so that image uniformity of the display device is less affected by the characteristic variations of the driver unit.

Adopted the method set forth above, the pixel circuit 10 of the invention consists of a switch unit 1, a driver unit 2, a compensation unit 3, a storage unit 4 and an OLED 5.

The switch unit 1 may be a thin film transistor (TFT) which has two inputs 11 and 12 connecting respectively to a scan line S and a data line D.

The driver unit 2 may be a TFT which has one input 21 connecting to an output 33 of the compensation unit 3 and the other input 22 connecting to the juncture of an output 13 of the switch unit 1 and an input 32 of the compensation unit 3.

The compensation unit 3 may be a TFT which has one input 31 connecting to a supply line P and the other input 32 connecting to the output end 13 of the switch unit 1.

The storage unit 4 includes a capacitor which has one end connecting to the supply line P and another end connecting to the output 13 of the switch unit 1.

The OLED 5 has an input connecting to an output end 23 of the driver unit 2 and an output end grounded.

The switch unit 1 can be turned on when the scan line S is selected. The data line D is connected to the storage unit 4 through the switch unit 1 and, therefore, the established data voltage level of the data line D can be stored into the storage unit 4. The driver unit 2 outputs a current to illuminate the OLED 5. The current flowing through the OLED 5 determines the brightness of the OLED 5.

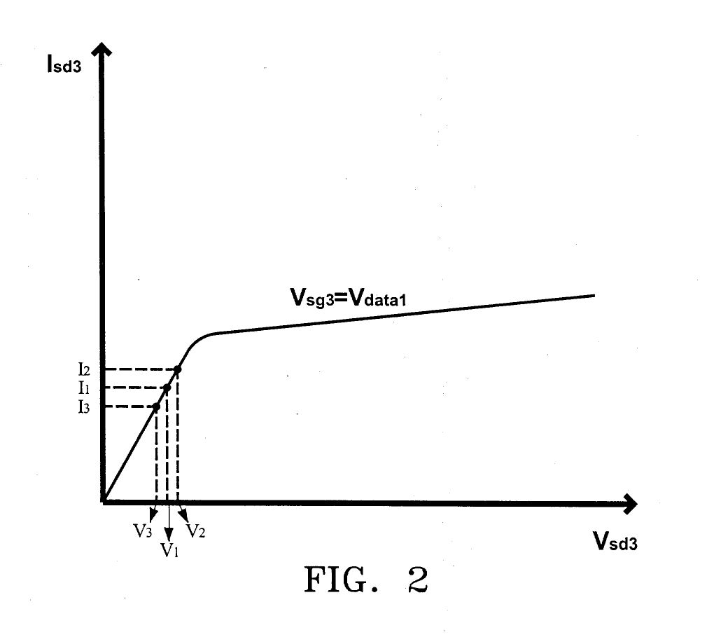

Refer to FIG. 2 for the current-voltage relationship of the compensation unit 3 of the invention. As shown in the drawing, when the voltage difference Vc stored in the storage unit 4 is equal to Vdata1, a Vsg3 equaling to Vdata1 on the compensation unit 3 is provided. And if the threshold voltage Vth of the driver unit 2 is at the normal value, the voltage drop Vsd3 across the compensation unit 3 has a normal value V1. Subtracted Vsd3 across the compensation unit 3 from the voltage difference Vc of the storage unit 4 becomes Vsg2 for the driver unit 2. Thus the driver unit 2 may output a normal current I1.

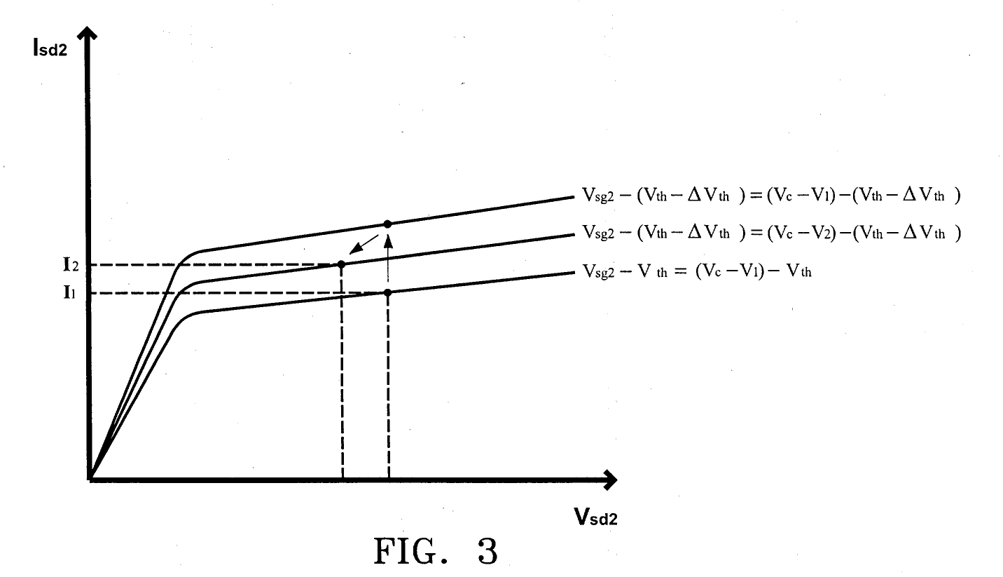

Refer to FIG. 3 for the current-voltage relationship of the driver unit 2 when Vth is smaller. As shown in the drawing, when the threshold voltage of the driver unit 2 is smaller and equal to Vth−ÄVth, the driver unit 2 will have a larger current output which will pass through the compensation unit. 3 to increase Vsd3 to become V2. Hence Vsg2 of the driver unit 2 becomes smaller. As a result, output current I2 of the driver unit 2 does not exceed the normal value I1 too much and the image uniformity of the display device is less affected by the characteristic variation of the threshold voltage of the driver unit 2.

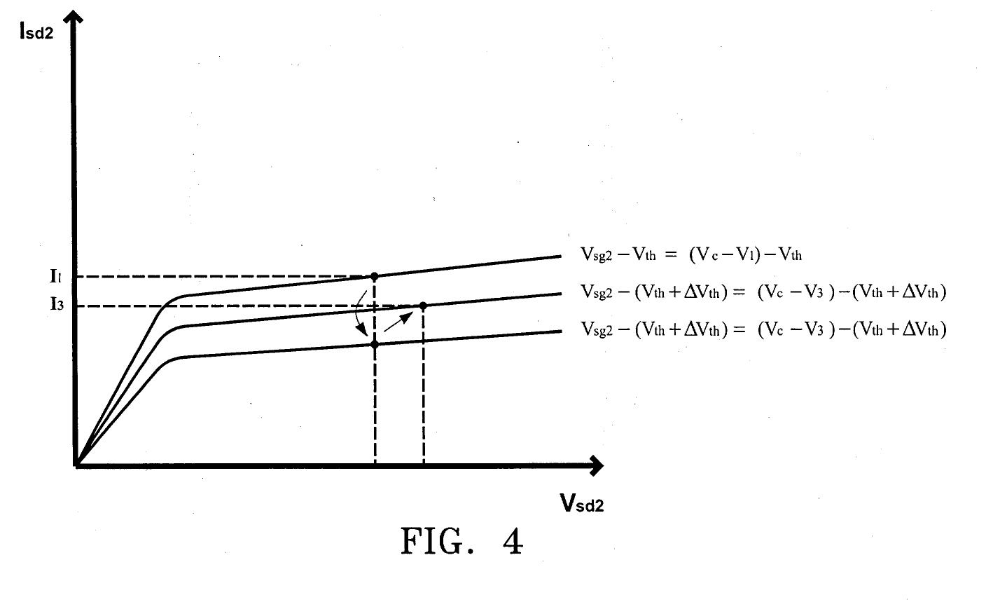

Refer to FIG. 4 for the current-voltage relationship of the driver unit 2 when Vth is larger. As shown in the drawing, when the threshold voltage of the driver unit 2 is larger and equal to Vth+ÄVth, the driver unit 2 will have a smaller current output which will pass through the compensation unit 3 to decrease Vsd3 to become V3. Hence Vsg2 of the driver unit 2 becomes larger. As a result, output current I3 of the driver unit 2 is not less than the normal value I1 too much and the image uniformity of the display device is less affected by the characteristic variation of the threshold voltage of the driver unit 2. Based on the above description, if there is a shift in the threshold voltage of the driver unit 2, the shift can be compensated for by an increase or decrease in the voltage Vsd3 across the compensation unit 3 and the voltage Vsg2 of the driver unit 2.

The most notable feature of the invention is that the compensation unit 3 can automatically adjust the characteristic curve of the load according to the input voltage signal (i.e. the voltage difference Vc stored in the storage unit 4) thereby adjust the voltage drop Vsd3 across the compensation unit 3 when output currents are different. Thus even if the driver unit 2 has to output a larger current, the compensation unit 3 can still function with the lower voltage drop occurred across two ends so that the circuit can provide voltage with a lower power supply.

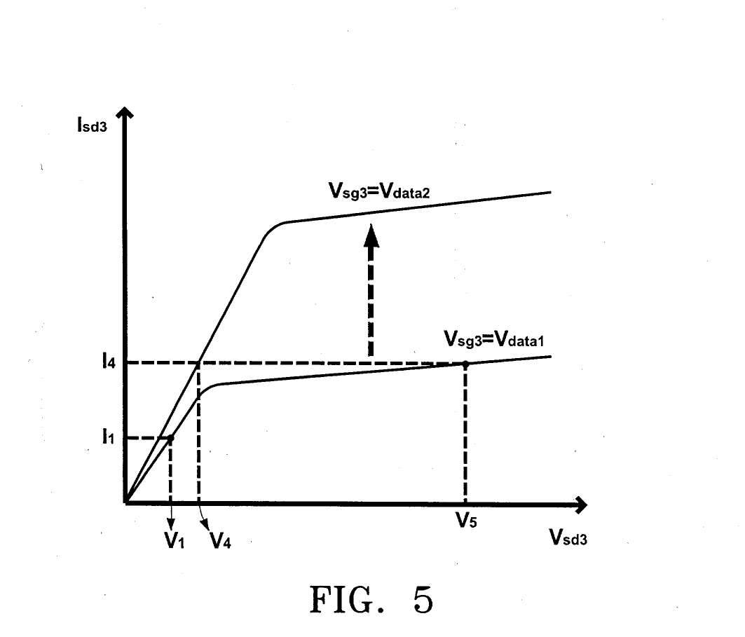

Refer to FIG. 5 for the current-voltage relationship of the compensation unit of the invention under different input voltage signals. As shown in the drawing, when the voltage difference Vc stored in the storage unit 4 is smaller and equal to Vdata1, Vsg3 (equals Vdata1) of the compensation unit 3 is also smaller. If the threshold voltage Vth of the driver unit 2 is at a normal value, the driver unit 2 will output a normal current I1 and Vsd3 of the compensation unit 3 will have a normal voltage drop V1.

When the voltage difference Vc stored in the storage unit 4 is larger and equal to Vdata2, Vsg3 (equals Vdata2) of the compensation unit 3 is also larger. If the threshold voltage Vth of the driver unit 2 is at a normal value, the driver unit 2 will output a normal current I4 and Vsd3 of the compensation unit 3 will have a normal voltage drop V4.

When the voltage difference Vc stored in the storage unit 4 changes from Vdata1 to Vdata2, if the compensation unit 3 does not automatically adjust the load characteristic curve, in the event that the driver unit 2 intends to output a larger current I4, the voltage drop Vsd3 across the compensation unit 3 will be equal to V5, and will be significantly greater than V4. In such a condition, a higher power supply must be employed to provide the voltage to enable the storage unit 4 to have a larger enough voltage difference Vc to maintain a greater output current I4.

In summary, the invention can provide the following advantages:

1. The invention employs an auto-adjustment active load to adjust Vsg of the driver unit to compensate for characteristic variations of the threshold voltage and mobility of the TFT, therefore can improve image uniformity of the OLED display device.

2. In the circumstances of different input voltage signals, the compensation unit of the invention can automatically adjust the load characteristic curve according to the input voltage signals thereby to adjust the voltage drop across the compensation unit when different normal output currents occurred. Thus even if the driver unit has to output a larger current, the compensation unit can still function under a lower voltage drop across two ends. Hence the pixel device may function at a lower voltage of power supply.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An apparatus for achieving an active matrix organic light emitting diode (OLED) display device with uniform luminance which consists of a plurality of pixel devices, each of the pixel devices comprising:
a switch unit having two input ends and an output end, the two input ends connecting respectively to a data line and a scan line;
a storage unit having one end connecting to a supply line and another end connecting to the output end of the switch unit;
a compensation unit having two input ends connecting respectively to the supply line and the output end of the switch unit;
a driver unit having two input ends and an output end, one input end connecting to an output end of the compensation unit and another input end connecting to a juncture of the output end of the switch unit and one input end of the compensation unit; and
an OLED having an input end connecting to the output end of the driver unit and an output end grounded.

2. The apparatus of claim 1, wherein the switch unit is a thin film transistor.

3. The apparatus of claim 1, wherein the driver unit is a thin film transistor.

4. The apparatus of claim 1, wherein the storage unit includes a capacitor.

5. The apparatus of claim 1, wherein the compensation unit is a thin film transistor.

6. A method for achieving an active matrix organic light emitting diode (OLED) display device with uniform luminance which consists of a plurality of pixel devices, each of the pixel devices comprising a driver unit to drive the OLED to illuminate, the method comprising steps of:
providing a compensation unit to adjust Vsg of the driver unit; and
compensating for the characteristic variations of the driver unit to make the display device less affected by the characteristic variations of the driver unit.
